(19) United States
(12) Patent Application Publication
(10) Pub. No.: US 2004/0112438 A1
(43) Pub. Date: Jun. 17, 2004

(54) Electrical switch

(76) Inventors: Alain Benoit, Vaujours (FR); Remi Demerssemann, Paris (FR); Philippe Come, Senlis (FR); Emmanuel Fraisse, Paris (FR)

Correspondence Address: Leo H. McCormick Jr, 2112 Mishawaka Avenue, P.O. Box 4721, South Bend, IN, 46634, US

(21) Appl. No.: 10/696,265

(22) Filed: Oct. 29, 2003

(30) Foreign Application Priority Data
Sep. 11, 2002 (FR) 02/11275

(51) Int. Cl. F16K 37/00

(52) U.S. Cl. 137/558

(57) ABSTRACT

An electrical switch for a level detection device in a functional fluid container (12) of a motor vehicle brake system, comprises two electrically conductive terminals (32, 34) and a first reed bulb (36), forming a dipole electrically connected to the two conductive terminals (32, 34). The reed bulb (36) is capable of occupying two states, one open and one closed, each state depending on whether the situation is normal or exceptional. The switch furthermore comprises a second reed bulb (36) forming a dipole electrically connected to the two conductive terminals (32, 34), this second reed bulb (36) functioning redundantly with respect to the first reed bulb (36)

The present invention relates to an improved electrical switch and to an assembly forming a brake fluid reservoir comprising this switch.

### BACKGROUND OF THE INVENTION

An electrical switch for a device for level detection in a functional fluid container of a motor vehicle brake system is already known in the prior art, this switch being of the type comprising two electrically conductive terminals and a first reed bulb, forming a dipole electrically connected to the two conductive terminals, the reed bulb being capable of occupying two states, one open and one closed, each state depending on whether the situation is normal or exceptional.

A switch of this type is advantageously used in an assembly forming a brake fluid reservoir for a motor vehicle brake system.

An assembly of this type generally comprises a brake fluid container and means for detecting a reference level of brake fluid in the container. These detection means are intended to detect a brake fluid level corresponding to an insufficient volume of this fluid in the container.

The detection means usually have a magnetic field source carried by a float which can move substantially vertically in the container, and an electrical switch of the aforementioned type, which is carried by a fixed support secured to the container and is capable of changing state as a function of the relative position of the magnetic field source and the switch. The switch is generally arranged in a housing forming a fixed support, so as to be insulated from the brake fluid held in the container.

When the volume of brake fluid in the container is insufficient, the reed bulb occupies its exceptional state and causes an alarm to be triggered.

Malfunctions of the electrical switch are sometimes encountered, due in particular to the following causes:

accidental cracking of the reed bulb due to impacts or accidental bending when the switch is being fitted in its housing, this cracking becoming worse over the course of time owing to the vibrations and temperature variations to which the assembly forming a reservoir is subjected;

breakage of the reed bulb due to impacts or large deformations experienced by the container of the assembly forming a reservoir; and

contamination of the reed bulb by a particle which prevents this bulb from occupying its exceptional state (contamination either by an insulating particle when the normal state of the reed bulb corresponds to the open state of this bulb, or by a conductive particle when the normal state of the reed bulb corresponds to the closed state of this bulb).

The reliability of the electrical switch depends on the reliability of the reed bulb. Therefore, whenever the reed bulb suffers a malfunction resulting from one of the above causes, the electrical switch can no longer change state and the detection means are therefore not effective in detecting a lack of brake fluid in the container of the assembly forming a reservoir.

### SUMMARY OF THE INVENTION

It is an object of the invention to improve the reliability of the electrical switch.

To this end, the invention relates to an electrical switch of the aforementioned type, characterized in that it comprises a second reed bulb forming a dipole electrically connected to the two conductive terminals, this second reed bulb functioning redundantly with respect to the first reed bulb.

According to characteristics of various embodiments of this switch:

the first and second reed bulbs are connected in parallel to the two conductive terminals, the normal state of each reed bulb corresponding to the open state of this bulb; and

the first and second reed bulbs are connected in series to the two conductive terminals, the normal state of each reed bulb corresponding to the closed state of this bulb.

The invention also relates to an assembly forming a reservoir for a functional fluid of a motor vehicle brake system, of the type comprising:

a functional fluid container; and

means for detecting a reference level of functional fluid in the container, having a magnetic field source carried by a float which can move substantially vertically in the container, and an electrical switch which is carried by a fixed support secured to the container and is capable of changing state as a function of the relative position of the magnetic field source and the switch, characterized in that the electrical switch is as defined above.

According to other characteristics of this assembly:

the reference level corresponds to a fluid level below which the volume of functional fluid in the container is insufficient; and

the magnetic field source is a magnet.

The invention will be understood more clearly on reading the following description, which is given solely as an example and with reference to the drawings.

### BRIEF DESCRIPTION OF THE DRAWINGS

FIG. 1 is a view in vertical section of an assembly forming a reservoir according to the invention;

FIG. 2 is a schematic view of a first embodiment of the electrical switch of the assembly forming a reservoir illustrated in FIG. 1; and

FIG. 3 is a schematic view of a second embodiment of the electrical switch of the assembly forming a reservoir illustrated in FIG. 1.

### DETAILED DESCRIPTION OF THE INVENTION

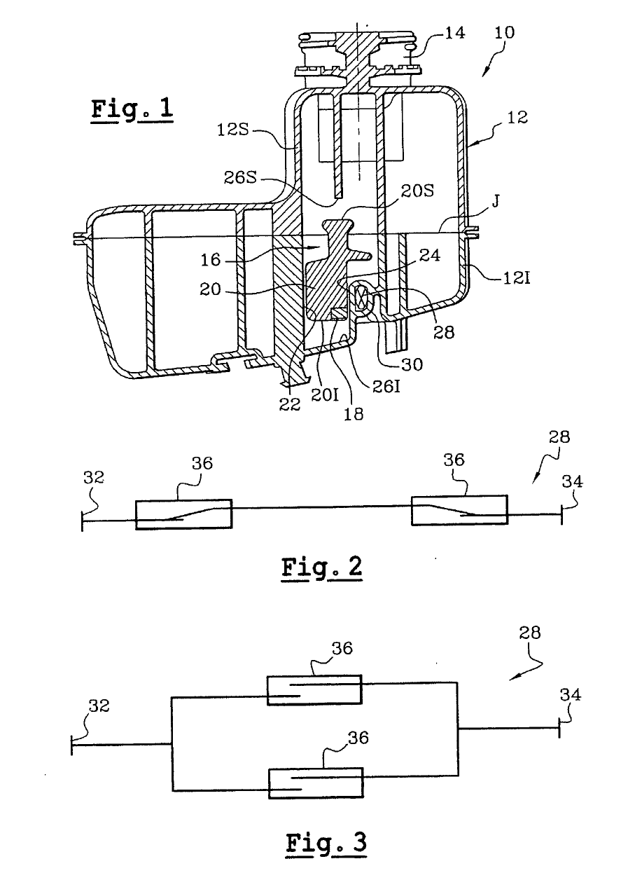

FIG. 1 represents an assembly forming a brake fluid reservoir for a motor vehicle brake system. This assembly according to the invention is denoted by the overall reference 10. In what follows, the vertical and horizontal directions correspond to the directions usually defined with respect to a plumb line.

The assembly 10 comprises a brake fluid container 12 delimited by two half-shells, respectively a lower one 12I and an upper one 12S. The two half-shells 12I, 12S, which are preferably made of plastic, are provided with complementary joining edges delimiting a join plane J.

The upper half-shell 12S of the container comprises means for access to this container, which are provided in particular with a neck 14 carrying screw-on means for a closure cap of the container (not shown).

The assembly 10 also comprises means 16 for detecting a reference level of brake fluid in the container 12. This reference level of the brake fluid corresponds substantially to a fluid level below which the volume of brake fluid in the container is insufficient.

The detection means 16 comprise a magnetic field source, consisting for example of a permanent magnet 18, carried by a float 20 which can move substantially vertically in the container 12.

The float 20 comprises a lower end 20I and an upper end 20S. It will be noted that the magnet 18 is fixed on the float 20 closer to the lower end 20I of this float than to the upper end 20S of this float. The magnet 18 preferably coincides substantially with the lowermost point of the float 20.

The float 20 is guided substantially vertically in the container 12 by interaction of its external surface with substantially vertical walls 22, 24 which are secured to the container 12 and extend inside this container 12.

The vertical travel of the float 20 is limited by means comprising, for example, a lower stop 26I and an upper stop 26S, which are secured to the container 12 and are intended to interact respectively with the lower end 20I and the upper end 20S of the float. These travel-limiting stops 26I, 26S, formed respectively inside the lower half-shell 12I and the upper half-shell 12S of the container, define respective bottom and top extreme positions of the float 20.

The detection means 16 also comprise an electrical switch 28 according to the invention, which is carried by a fixed support 30 secured to the lower half-shell 12I of the container. The fixed support 30, which is delimited by a wall integral with the lower half-shell 12I, forms a leaktight housing for the switch 28 so as to insulate it from the brake fluid held in the container 12.

It will be noted that the wall which delimits the fixed support 30 carrying the switch 28 forms one of the walls 24 contributing to the vertical guidance of the float 20 in the container 12.

It will also be noted that the magnet 18 is carried by a part of the float 20 which is offset horizontally with respect to the switch 28.

As will be specified in more detail below, the switch 28 is capable of occupying a first state and a second state as a function of the relative position of the magnet 18 and the switch 28, each state being normal or exceptional depending on the situation.

FIG. 2 represents a first embodiment of the switch 28. In this case, the switch 28 is closed in its normal state and open in its exceptional state. The switch 28 comprises two electrically conductive terminals 32, 34 and two conventional reed bulbs 36. The two reed bulbs 36 form two dipoles connected in series between the two conductive terminals 32, 34.

According to a conventional function of a reed bulb, it occupies a closed first state when it is subjected to the magnetic field of the magnet 18, and an open second state when it is free from the effect of the magnetic field of the magnet 18.

In the first embodiment of the switch 28, the first and second states of each reed bulb 36, that is to say the closed and open states of each reed bulb 36, correspond respectively to the normal state of the switch 28 illustrated in FIG. 2 and to the exceptional state of the switch 28.

The switch 28 occupies its first state (switch closed) when the magnet 18 is substantially aligned horizontally with this switch 28 (minimum distance between the magnet 18 and the switch 28) and its second state (switch open) when the magnet 18 is offset vertically with respect to the switch 28, as represented in FIG. 1.

The upper stop 26S is positioned inside the container 12 so that the magnet 18 and the switch 28 are substantially aligned horizontally when the upper end 20S of the float interacts with this stop 26S in order to limit the travel of this float upwards. The switch 28 is hence closed when the brake fluid level in the container 12 is sufficient to keep the upper end 20S of the float in contact with the upper stop 26S.

When the level of brake fluid in the container 12 falls, the float 20 is pulled downwards. The magnet 18 therefore moves away from the switch 28 by vertical displacement, making this switch 28 enter its second state (switch open) as soon as the fluid level reaches a predetermined reference level, below which the volume of fluid in the container 12 is insufficient. The change of state of the switch 28 makes it possible to trigger an alarm warning the user of the vehicle that he or she should refill the assembly 10 with brake fluid.

Each reed bulb 36 functions redundantly with respect to the other reed bulb 36. In the event of a malfunction of a first reed bulb 36, preventing it from occupying its open exceptional state (cracking or destruction of the bulb, conductive particle contaminating the bulb so as to force contact between the reeds, etc.), the correctly functioning second reed bulb 36 can occupy the open exceptional state. Moreover, because of the series connection of the two reed bulbs 36, the switch 28 occupies the open exceptional state whenever one of the reed bulbs 36 occupies its open exceptional state, making it possible to trigger the alarm.

It will therefore be understood that the two mutually redundant reed bulbs 36 improve the reliability of the switch 28. The reliability of the switch 28 could of course be improved by increasing the number of reed bulbs 36 connected in series between the two terminals 32, 34.

In the second embodiment of the switch 28, represented in FIG. 3, the normal and exceptional states of the switch 28 are reversed with respect to the first embodiment. This second embodiment of the invention is suitable for an alternative embodiment of the assembly 10 forming a reservoir according to which, on the one hand, the magnet 18 is far away from the switch 28 when the volume of brake fluid in the container 12 is sufficient and, on the other hand, the magnet 18 and the switch 28 are substantially aligned horizontally when the fluid level reaches a predetermined reference level, below which the volume of fluid in the container 12 is insufficient.

In the case of FIG. 3, the switch 28 is hence open in its normal state and closed in its exceptional state. The two reed bulbs 36 form two dipoles connected in parallel to the two conductive terminals 32, 34. The first and second states of each reed bulb 36 are respectively a closed state, corresponding to the exceptional state of the switch 28, and an open state corresponding to the normal state of the switch 28 illustrated in FIG. 3.

As in the first embodiment of the switch 28, each reed bulb 36 functions redundantly with respect to the other reed bulb 36. In this second embodiment, however, in the event of a malfunction of a first reed bulb 36 preventing it from occupying its closed exceptional state (cracking or destruction of the bulb, insulating particle contaminating the bulb so as to prevent contact between the reeds, etc.), the correctly functioning second reed bulb 36 can occupy the closed exceptional state. Moreover, because of the parallel connection of the two reed bulbs 36, the switch 28 occupies the closed exceptional state whenever one of the reed bulbs 36 occupies its closed exceptional state, making it possible to trigger the alarm.

The reliability of the switch 28 could, of course, be improved by increasing the number of reed bulbs 36 connected in parallel to the two terminals 32, 34.

The invention is not limited to the embodiments described above. In particular, the switch according to the invention may be fitted to a device for detecting of the level of a functional fluid other than conventional brake fluids.

We claim:

1. An electrical switch for a device for level detection in a functional fluid container (12) of a motor vehicle brake system, this switch (28) being of the type comprising two electrically conductive terminals (32, 34) and a first reed bulb (36), forming a dipole electrically connected to the two conductive terminals (32, 34), the reed bulb (36) being capable of occupying two states, one open and one closed, each state depending on whether the situation is normal or exceptional, characterized in that it comprises a second reed bulb (36) forming a dipole electrically connected to the two conductive terminals (32, 34), this second reed bulb (36) functioning redundantly with respect to the first reed bulb (36).

2. An electrical switch according to claim 1, characterized in that the first and second reed bulbs (36) are connected in parallel to the two conductive terminals (32, 34), the normal state of each reed bulb (36) corresponding to the open state of this bulb.

3. An electrical switch according to claim 1, characterized in that the first and second reed bulbs (36) are connected in series to the two conductive terminals (32, 34), the normal state of each reed bulb (36) corresponding to the closed state of this bulb.

4. An assembly forming a reservoir for a functional fluid of a motor vehicle brake system, of the type comprising:
a functional fluid container (12), and
means (16) for detecting a reference level of functional fluid in the container (12), having a magnetic field source (18) carried by a float (20) which can move substantially vertically in the container (12), and an electrical switch (28) which is carried by a fixed support (30) secured to the container and is capable of changing state as a function of the relative position of the magnetic field source (18) and the switch (28), characterized in that the electrical switch (28) is in accordance with any one of the preceding claims.

5. The assembly according to claim 4, characterized in that the reference level corresponds to a fluid level below which the volume of functional fluid in the container (12) is insufficient.

6. The assembly according to claim 4, characterized in that the magnetic field source (18) is a magnet.
